(19) United States
(12) Patent Application Publication
(10) Pub. No.: US 2024/0028911 A1
(43) Pub. Date: Jan. 25, 2024

(54) EFFICIENT SAMPLING OF EDGE-WEIGHTED QUANTIZATION FOR FEDERATED LEARNING

(71) Applicant: Dell Products L.P., Round Rock, TX (US)

(72) Inventors: Pablo Nascimento da Silva, Niteroi (BR); Vinicius Michel Gottin, Rio de Janeiro (BR); Paulo Abelha Ferreira, Rio de Janeiro (BR)

(21) Appl. No.: 17/814,055

(22) Filed: Jul. 21, 2022

(51) Int. Cl. G06N 5/02

(52) U.S. Cl. CPC G06N 5/022

(57) ABSTRACT

One example method includes running an edge node sampling algorithm using a parameter ‘s’ that specifies a number of edge nodes to be sampled, using historical statistics from the edge nodes, calculating a composite time for each of the edge nodes, and the composite time comprises a sum of a federated learning time and an execution time of a quantization selection procedure, identifying an outlier boundary, defining a cutoff threshold based on the outlier boundary, and selecting, for sampling, the edge nodes that are at or below the cutoff threshold.

### RELATED APPLICATION

This application is related to U.S. patent application Ser. No. 17/869,998, entitled EDGE-WEIGHTED QUANTIZATION FOR FEDERATED LEARNING, and filed the same day herewith. The aforementioned application is incorporated herein in its entirety by this reference.

### FIELD OF THE INVENTION

Embodiments of the present invention generally relate to federated learning processes. More particularly, at least some embodiments of the invention relate to systems, hardware, software, computer-readable media, and methods for intelligently selecting edge nodes to be used in the identification and assessment of quantization processes for convergence performance.

### BACKGROUND

The goal of federated learning is to train a centralized global model while the training data remains distributed on many client nodes. In practice, updating the central model involves frequently sending from the workers each gradient update, which implies large bandwidth requirements for huge models. One way of dealing with this problem is compressing the gradients sent from the client to the central node. Even though gradient compression may reduce the network bandwidth necessary to train a model, gradient compression also has the attendant problem that it decreases the convergence rate of the algorithm, that is, of the model.

There may be cases where the non-quantized, non-compressed updates could result in a sufficiently faster convergence rate to justify the higher communication costs. However, the development of methods for intelligently compressing gradients is desirable for FL applications. Particularly when it can be done by deciding when to send a compressed gradient and when to send an uncompressed gradient while maintaining an acceptable convergence rate and accuracy. Some of such approaches rely on random sampling of edge nodes to perform a quantization assessment step at every federated learning cycle. This approach may be problematic however, since the randomly selected edge nodes may not be well suited to perform the quantization assessments.

In more detail, various problems may arise when the central node selects a relevant number of impaired edge nodes to perform the quantization assessment process. For example, delay of the federated learning cycle may occur. The selection of the edge nodes used to perform the quantization assessment is made using a random selection procedure. This process allows for impaired nodes to be selected and, consequently, the whole federated learning process may be delayed due to such impairments. This is because a federated learning process typically only proceeds when all nodes send their respective gradient values, with selected quantizations, to update the central node. So, as the central node waits for one or more impaired nodes to respond, the FL process can be delayed or even stall.

Another problem with some node selection processes is the inaccuracy in the selected quantization. For example, some approaches may employ a parameter ‘s,’ which dictates the number of edge nodes where the quantization selection procedure will run. Such approaches select the edge nodes to perform the quantization by using a random selection, which means that some of the selected nodes can be inadequate to run the quantization selection procedure due to impairment or underrepresentation of data in the application domain. Further, the subset of responding edge nodes may be unrepresentative of the domain, such as when that subset is too small due to several edge nodes being ‘dropped’ from consideration.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example federated learning setting.

FIG. 2 discloses a sign compressor being used to compress a gradient vector.

FIG. 3 discloses an illustration of training iterations and evolution of gradient size and convergence rate.

FIG. 4 discloses an overview of a sampling method according to some example embodiments.

FIG. 5 discloses an example of a sampling method in a federation of edge storage devices when ‘s’=2.

FIG. 6 discloses calculation of an example binary vector ‘B.’

FIG. 7 discloses operations for generating, and aggregating, binary vectors.

FIG. 8 discloses example training times for a collection of storage edge devices.

FIG. 9 discloses performance of an example of an efficient sampling algorithm.

FIG. 10 discloses a flowchart of example operations performed by a sampled node.

FIG. 11 discloses a flowchart of example operations performed by a non-sampled node.

FIG. 12 discloses operations for collecting, and aggregating, historical statistics.

FIG. 13 discloses the processing of statistics at a central node.

FIG. 14 discloses an example boxplot used to identify outlier edge nodes.

FIG. 15 discloses an example method for efficient sampling.

FIG. 16 discloses the use of an example boxplot and efficient sampling method to identify candidate edge nodes.

FIG. 17 discloses a computing entity operable to perform any of the disclosed methods, processes, and operations.

### DETAILED DESCRIPTION OF SOME EXAMPLE EMBODIMENTS

Embodiments of the present invention generally relate to federated learning processes. More particularly, at least some embodiments of the invention relate to systems, hardware, software, computer-readable media, and methods for intelligently selecting edge nodes to be used in the identification and assessment of quantization processes for convergence performance.

In general, at least some example embodiments of the invention embrace processes to intelligently select the quantization method by using more representative, and unimpaired, edge nodes where the quantization selection procedure will run. Note that as used herein ‘quantization’ includes, but is not limited to, a process for mapping the values in a large set of values to the values in a smaller set of values. One example of quantization is data compression, in which a size of a dataset is reduced, in some way, to create a smaller dataset that corresponds to the larger dataset, but the scope of the invention is not limited to data compression as a quantization approach.

Some particular embodiments provide for training federated learning models with a dynamic selection of gradient compression at the central node, based on an edge-side assessment of the estimated convergence rate at selected edge nodes. Embodiments may additionally perform: capturing and storing the response times of edge nodes selected to perform the quantization assessment process in each federated learning cycle; and, capturing and storing statistics of the response times of the training task, at each federated learning cycle, for edge nodes in the federation. These historical data may be used to determine a sufficiently large, and adequate, subset of edge nodes to perform the quantization assessment process for the next federated learning cycle. The determination may occur at the central node and may not incur any additional processing overhead for the edge nodes.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, an embodiment of the invention may implement non-random, intelligent, selection of one or more edge nodes best suited to run a quantization selection procedure. An embodiment may reduce, or eliminate, the use of randomly selected edge nodes that are not expected to provide acceptable performance in running a quantization selection procedure. An embodiment may implement a process that enables selection of edge nodes that are able to run a quantization selection procedure without delaying a federated learning cycle. Various other advantages of example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Overview

Federated Learning (FL) is a machine learning technique capable of providing model training from distributed devices while keeping their data private. This can be of great value to a business since embodiments may train machine learning models for a variety of distributed edge devices and easily apply them to various products such as, for example, laptops, servers, and storage arrays.

A goal of federated learning is to train a centralized global model while the training data for the global model remains distributed on many client nodes, which may take the form of edge nodes, for example. In this context, embodiments may assume that the central node can be any machine with reasonable computational power. Training a model in an FL setting may be done as follows. First, the central node may share an initial model, such as a deep neural network, with all the distributed edge nodes. Next, the edge nodes may train their respective models using their own data, and without sharing their data with other edge nodes. Then, after this operation, the central node receives the updated models from the edge nodes and aggregates those updated models into a single central model. The central node may then communicate the new model to the edge nodes, and the process may repeat for multiple iterations until it reaches convergence, that is, the configuration of the model has converged to a particular form.

In practice, updating the central model may involve frequently sending from the workers each gradient update, which implies large bandwidth requirements for large models. Hence, a typical optimization in federated learning may be to compress the weights in both ways of communication—the edge node compresses the updates sent to the central node, while the central node compresses the updates to be broadcast to the edge nodes for the next training cycle. Research shows that, in some instances at least, applying aggressive compression, such as down to one bit per weight, may be an efficient trade-off between communication overhead and convergence speed as a whole.

However, such aggressive compression may come at a price, namely, poor model convergence performance. In contrast, there are cases where the non-quantized, non-compressed updates could result in a sufficiently faster convergence rate to justify the higher communication costs. The development of methods for intelligently compressing gradients is desirable for FL applications. Especially when it can be done by deciding when to send a compressed gradient, and when to send an uncompressed gradient, while maintaining the convergence rate and accuracy at acceptable levels.

As noted in the ‘Related Application’ referred to herein, methods have been developed for training FL models with a dynamic selection of gradient compression at the central node, based on an edge-side assessment of the estimated convergence rate at selected edge nodes. Such methods may include a random sampling of edge nodes to perform a quantization assessment step at every federated learning cycle. An issue that arises with such methods is that a naïve selection of edge nodes, such as a random selection, to perform the quantization assessment process is slow, so overhead or otherwise impaired nodes may eventually be selected. Thus, if edge nodes that take too long to complete that process are selected, the whole federated learning cycle may be delayed. Also, the dynamic quantization approach aims for extreme scalability, typical in federated learning, and thus it assumes no control mechanisms for the communication of the quantization assessment process results, except dropping edge nodes if they take too long to respond.

### B. Context for Some Example Embodiments

### B.1 Deep Neural Network Training

The training of machine learning models may rely on training algorithms, usually supported by optimization. Training approaches usually rely on the backpropagation algorithm and the Stochastic Gradient Descent (SGD) optimization algorithm for deep neural networks. Before initialization, a network topology of neurons and interconnecting weights may be chosen. This topology may determine how the calculations will flow through the neural network. After that, an initialization may be performed, setting the weight values to some random or predefined values. Finally, the training algorithm may separate batches of data and flow them through the network. Afterward, one step of backpropagation may occur, which will set the direction of movement of each of the weights through the gradients. Finally, the weights may move by a small amount, ruled by the algorithm learning rate. This process may go on for as many batches as necessary until all training data is consumed. This more significant iteration is called an epoch. The training may go on until a predefined number of epochs is reached, or any other criteria are met, for example, no significant improvement seen over the last ‘k’ epochs.

### B.2 Federated Learning

Federated Learning (FL) is a machine learning technique where the goal is to train a centralized model while the training data remains distributed on many client nodes. Typically, the network connections and the processing power of such client nodes are unreliable and slow. The main idea is that client nodes can collaboratively learn a shared machine learning model, such as a deep neural network, while keeping the training data private on the client device, so the model can be learned, and refined, without storing a huge amount of data in the cloud or in the central node. Every process with many data-generating nodes can benefit from such an approach, and these examples are countless in the mobile computing world.

In the context of FL, and as used herein, a central node can be any machine with reasonable computational power that receives the updates from the client nodes and aggregates these updates on the shared model. A client node may comprise any device or machine that contains data that may be used to train the machine learning model. Examples of client nodes include, but are not limited to, connected cars, mobile phones, storage systems, network routers, and autonomous vehicles.

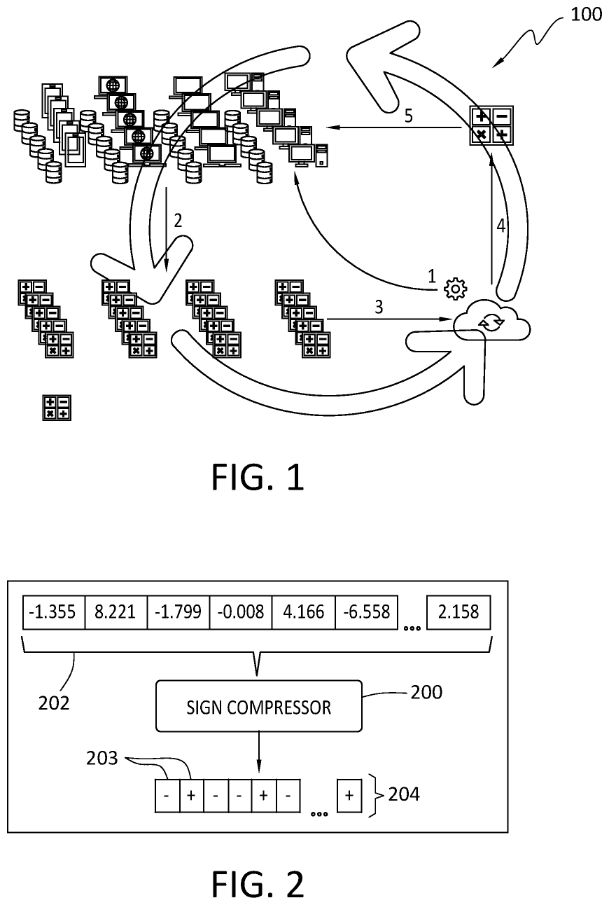

With reference now to FIG. 1, an example methodology 100 for training of a neural network in a federated learning setting is disclosed. In general, the methodology 100 may operate iteratively, or in cycles. These cycles may be as follows: (1) the client nodes download the current model from the central node—if this is the first cycle, the shared model may be randomly initialized; (2) then, each client node may train the model, using local client node data, during a user-defined number of epochs; (3) the model updates may then be sent from the client nodes to the central node(s)—in example embodiments of the invention, such updates may comprise vectors containing the gradients, that is, the changes to the model; (4) the central node may then aggregate these vectors and update the shared model with the aggregated vectors; and, (5) if the predefined number of cycles N is reached, finish the training—otherwise, return to (1) again.

### B.3 Example Compression Techniques for Federated Learning

There is currently interest in a number of different methods with the aim of reducing the communication cost of federated learning algorithms. One of the approaches for gradient compression is the SIGNSGD, or sign compression, with majority voting. In general, and as shown in FIG. 2, a sign compressor 200 may receive various gradient values 202, which may be positive or negative. The sign compressor 200 may strip out the magnitude information from each gradient value, leaving only a group of signs 203 which, together, define a gradient vector 204. As shown, the signs 203 may be positive or negative, and because the gradient vector 204 includes only the signs, the size of the gradient vector is thereby reduced relative what its size would be if the gradient values had been retained.

Thus, for example, this sign compression approach may allow sending 1-bit per gradient component, which may constitute a 32× gain compared to a standard 32-bit floating-point representation. However, there is still no method to reduce the compression without impacting the convergence rate or final accuracy.

### B.4 Dynamic Edge-weighted Quantization for Federated Learning

### B.4.1 Overview

This section addresses edge-weighted quantization in federated learning, examples of which are disclosed in the ‘Related Application’ referred to herein. As noted above, gradient compression in federated learning may be implemented by employing quantization such as, for example, a 1-bit (or sign) compression from a 32-bit float number, keeping only the mantissa or the sign. Of course, the compression of such algorithms is very powerful, even though the learning process becomes less informative since gradients are limited in information and direction regarding the loss function.

Hence, example embodiments of the invention are directed to, among other things, methods for deciding when, that is, in which training cycle, to send (1) a complete 32-bit gradient, which is more informative than a compressed gradient, while also being larger in size than a compressed gradient, or (2) a quantized version of the gradient(s), which may be less informative that complete gradients, but smaller in size and therefore less intensive in terms of bandwidth consumption.

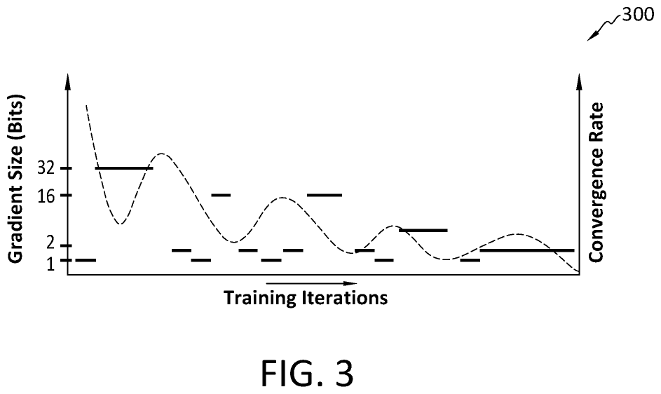

In general, example embodiments may deal with the problem of training a machine learning model using federated learning in a domain of distributed edge devices, such as edge storage devices. These edge devices may be specialized for intense tasks and consequently have limited computational power and/or bandwidth limitations. Thus, methods according to example embodiments that may leverage the data stored in these devices while using just small computational resources are beneficial. Thus, it may be useful to employ methods capable of using the smallest possible amount of computational resources, such as, in some example cases, the bandwidth and CPU processing. Note that improving the algorithm convergence rate may help reduce the total amount of data transmitted in a lengthy training procedure with powerful compression algorithms, such as 1-bit compression. FIG. 3 illustrates the positive effects of dynamically selecting the compression rate during the training iterations of the federated learning framework.

More specifically, as shown in the example graph 300 of FIG. 3, gradient size and model convergence rate may tend to increase/decrease in unison. Thus, a relatively small gradient size, while possibly desirable from a latency and bandwidth consumption perspective, may generally correspond to a relatively low, or slow, convergence rate. On the other hand, a relatively large gradient size, which may generally correspond to a relatively fast convergence rate, may nonetheless have significant bandwidth requirements. As shown in FIG. 3, the gradient size may, generally, tend to decrease with the number of iterations, although the convergence rate likewise may tend to decrease with the number of iterations. Thus, it may be helpful to strike a balance among various factors, namely, (1) gradient size, (2) convergence rate, and (3) the number of iterations performed (more iterations take longer to train the model, and thus also consume more resources).

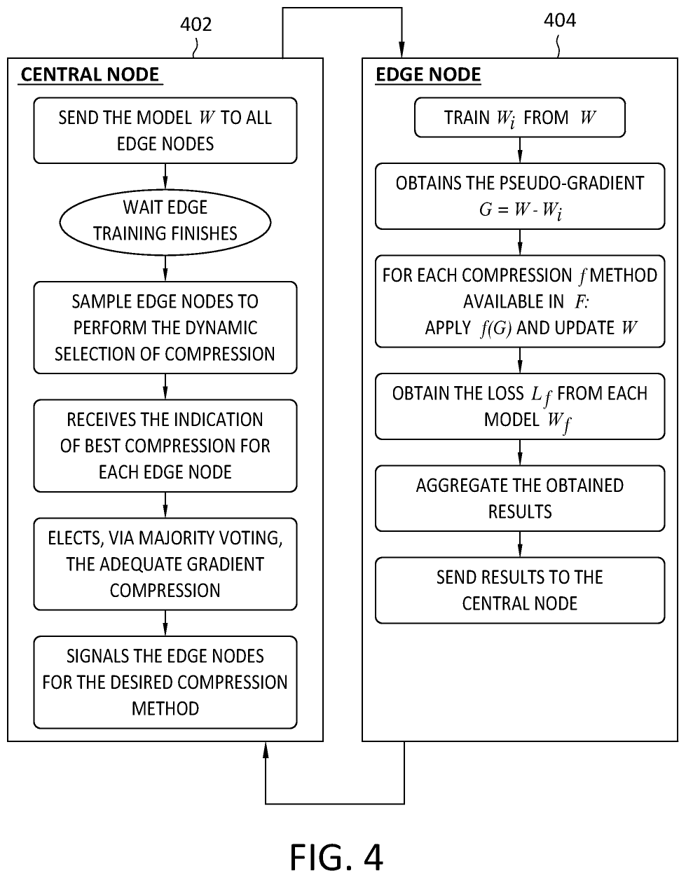

Thus, example embodiments may be directed to methods that include training machine learning models from a large pool of distributed edge storage arrays using federated learning while keeping the convergence rate small and using limited bandwidth. Embodiments may employ a method that samples several storage arrays, as disclosed elsewhere herein, and runs inside these devices a lightweight validation of the compression algorithm during the federated learning training, as disclosed elsewhere herein. Such embodiments may include getting a validation dataset inside the edge device, updating the model using the gradient compressor, training for some epochs, and evaluating the loss of this model. Then, each one of the sampled storage arrays, or other edge devices, may send its best compression algorithm to the central node. The central node may then aggregate the information received from the edge arrays, decide the best compression method for the federation, and inform the edge nodes of the selection made, as disclosed elsewhere herein. Thus, in methods according to some example embodiments, the edge nodes may compress the gradients of their training using the best compression algorithm and, the training process continues. The process may repeat for every t cycles of the federated learning training method. FIG. 4 gives a general overview of a method and technique according to some example embodiments.

In FIG. 4, the left part of the figure discloses example operations that may be performed inside a central node 402, while the right part of the figure discloses example operations that may be performed inside each one of the edge storage nodes. Note that some operations in FIG. 4 implicitly determine a waiting block for ensuring synchronous processing. Note that all the selected edge nodes may run the compression and update the model for all compressions in ‘F’ to find the best possible compressor, given the various factors, such as gradient size, convergence rate, and number of iterations performed, that may need to be balanced. The method running inside the edge node 404 may be a lightweight process, since each of the respective models at the edge nodes may be updated only by a small number of epochs.

### B.4.2 Sampling Edge Devices to Apply the Dynamic Selection

As noted herein, example embodiments of the invention may deal with a federation of edge devices. In practice, this federation may have a large number of workers used for training the machine learning model, possibly thousands, or more, devices in the federation. As such, it may be infeasible in some cases to run the example methods of some embodiments on every device. Thus, some embodiments may incorporate a sampling operation. This sampling operation may operate to randomly select a smaller number of edge workers so that they are used to choosing the best compressor for the whole federation. In some embodiments, the sampling method should keep the distribution of devices selected constant. That is, embodiments may not prefer one device to the detriment of others, rather, all devices should be selected the same amount of times. Note that even though embodiments may operate to choose a subset of the edge nodes to run a process for quantization selection, the federated learning training process may still be running in all the edge nodes, or in a defined number of edge nodes.

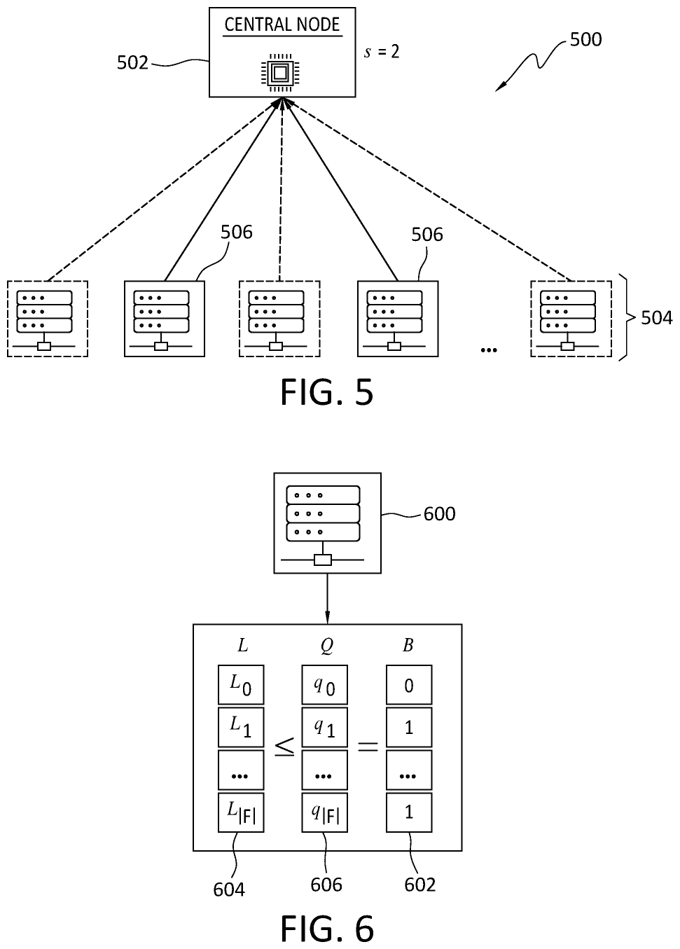

The number ‘s’ of devices designated to run a quantization selection procedure may be a pre-defined parameter determined by the user, or federation owner, for example. Thus, ‘s’ may represent the number, such as an integer number, of selected devices, or a percentage of the total number of devices, such as 10% for example. This is an implementation detail, however, and does not change the purpose of the quantization selection procedures disclosed herein. In some example implementations of a method according to some embodiments, the parameter ‘s’ may be dynamically selected according to a pre-defined metric. FIG. 5 shows an example of the sampling stage 500 that may be employed in example embodiments. In the example of FIG. 5, a central node 502 communicates with a group 504 of edge nodes, and the value of ‘s’ is set at s=2. Thus, of the group 504, only edge nodes 506 are sampled in this illustrative example.

### B.4.3 Distributed Selection of the Best Worker Compressor

Methods according to some example embodiments may comprise at least two parts running on different levels: (i) the first part may run in the central node; (ii) and the second part may run inside each one of the edge devices, examples of which include edge storage arrays, and the edge devices may be referred to herein as ‘workers.’ That is, the second part may be instantiated at each edge device in a group of edge devices, so that a respective instantiation of the second part is running, or may, at each edge device. The following discussion is directed to the portion, or stage, running inside the edge devices. The discussion is presented with reference to the particular example of edge storage arrays, but it should be understood that such reference is only for the purposes of illustration, and is not intended to limit the scope of the invention in any way.

First, each edge storage array may receive a model from the central node, as standard in any federated learning training. Then, each of the edge storage arrays may process the training stage of the model using the local data of that edge storage array. More specifically, the method running inside the edge node may operate as follows.

Let W be the definition of the model weights, synchronized across all nodes at the beginning of the cycle. Let ‘F’ be a set of known quantization functions, such as compression functions for example, which may include the identity function and the 1-bit, sign, compression function, or other maximum-compression function. Let be a set of loss value thresholds, one for each f∈F, with respect to the 1-bit, or sign, compression or other maximum-compression function.

At a training cycle, a set of selected edge storage nodes, such as are disclosed herein, may perform the following operations:
(1) train a model Wᵢ from W with the currently available training data;
(2) from the difference between Wᵢ and W, obtain a pseudo-gradient G;
(3) for each available gradient compression, or other quantization function, ƒ∈F, obtain a model W_{f} resulting from the updated model W with ƒ(G)—notice that for the identity function, W_{f}=Wᵢ;
(4) obtain a validation loss L_{f} for each model W_{f}—where L_{f}=g(X|W_{f}), g is the machine learning model parameterized by W_{f}, and X is the validation set of the node;
(5) for each validation loss L_{f}, compute a vector B to store whether losses are below the loss value threshold for that respective function—see the example in FIG. 6, discussed below; and
(6) communicate, for each f∈F, one bit with the result of the Boolean computation in (5), to the central node.

As shown in the example of FIG. 6, inside each selected edge node 600, that is, each edge node selected using an embodiment of the disclosed sampling methods, embodiments may operate, for each of one or more pairs of (L,Q), to calculate a binary vector B 602 value based on one or more validation losses L 604 and loss value thresholds Q 606. This vector 602 may contain information indicating whether or not a given compressor ƒ is better, in terms of its performance, than its pre-defined threshold. Thus, for example, if L>Q, that is, the loss experienced by running a quantization function at an edge node, is greater than a loss value threshold, then a value of ‘0’ may be added to the vector 602. On the other hand, if the loss is less than, or equal to, the loss value threshold, a value of ‘1’ may be added to the vector 602. In this example, vector 602 values of ‘1’ indicate that the associated quantization function has been determined by the edge node to have functioned acceptably, that is, at or below a maximum threshold for loss.

### B.4.4 Centralized Dynamic Selection of the Gradient Compression

The second part of one example method (see B.4.3 above) may run inside the central node. As used herein, a central node may comprise a server with reasonable computational power and a large capacity to deal with incoming information from the edge nodes. In the federated learning training, the central node is responsible for aggregating all node information and giving guidance to generate the next step model. In some example embodiments, the central node may also operate to define the best compression algorithm to use in the subsequent few training cycles. The process of selecting the ideal compression algorithm to reduce the communication bandwidth and improve the convergence rate of the federated learning training is defined as described below.

The method running in the central node may comprise the following operations:
(1) receive a respective set of binary vectors B from each of the sampled nodes;
(2) elect, via majority-voting or any other aggregation function h, a compression method, or other quantization method, that was selected by the majority of edge nodes as achieving an adequate compression/convergence tradeoff, as defined by Q (see, e.g., FIG. 6); and
(3) signal the edge nodes for the desired elected quantization level updates to be gathered.

At this point, the storage edge nodes, receiving that information, submit to the central node the updates. The central node may then perform an appropriate aggregation function, such as a federated average for example, on the received gradient updates in order to update the model W for the next cycle.

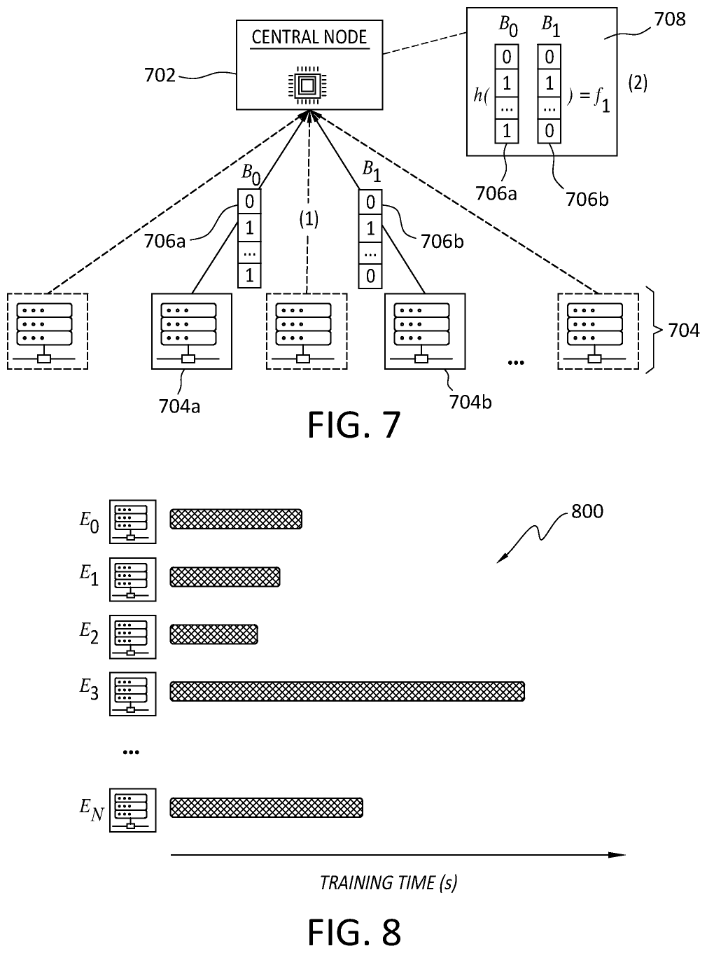

With reference now to the example of FIG. 7, a central node 702 is shown that is operable to communicate with a group of edge nodes 704. In general, and discussed above, the central node 702 may receive (1), such as from nodes 704a and 704b selected for sampling, respective binary vectors 706a and 706b computed by those nodes. After receipt of the binary vectors 706a and 706b, the central node 702 may then aggregate (2) those binary vectors 706a and 706b to define the compression algorithm ƒ₁ 708 that will be used for the next training iterations of the model (not shown in FIG. 7). After that the new compressor, that is, the compression algorithm ƒ₁ 708, is communicated back to all of the edge nodes 704, the training process continues.

### C. Further Aspects of Some Example Embodiments

Example embodiments may provide methods for training federated learning models with a dynamic selection of gradient compression at the central node, based on an edge-side assessment of the estimated convergence rate at selected edge nodes. As well, example embodiments may also perform capturing and storing the response times of edge nodes selected to perform the quantization assessment process at each federated learning cycle, and also perform capturing and storing statistics of the response times of the training task, at each federated learning cycle, for edge nodes in the federation. As noted earlier herein, these historical data may be used to determine a sufficiently large and adequate subset of edge nodes to perform the quantization assessment process for the next federated learning cycle. The determination may occur at the central node and may not incur any additional processing overhead for the edge nodes.

### C.1 Overview

Example embodiments may deal with the problem of training a machine learning model using federated learning in a domain of distributed edge storage devices. Thus, embodiments may define a set of edge storage devices as E with N devices. These devices may be specialized for intense tasks and have limited computational power and bandwidth limitations. Thus, methods that can leverage the data stored in these devices while using just small computational resources are beneficial. An enterprise may benefit from this training pattern to learn specific machine learning models running inside these devices. For that, it may be useful to implement a method capable of using the smallest possible amount of computational resources at one or more edge nodes, such as, in in some example embodiments, the bandwidth and CPU processing.

Example embodiments may operate to non-randomly sample a number s of edge devices, such as storage edge devices for example, to perform an evaluation procedure internally, that is, at the edge devices, that will identify the best quantization procedure for the whole process. In contrast, in processes that run a random sampling strategy, the federated learning cycle is delayed in some scenarios. All other edge nodes must wait until the processing of a single edge device end to proceed with the training. Consider for example, the scenario 800 in FIG. 8, which discloses the different respective training times for each edge device in a collection of storage edge devices. Note that the training time of each edge node is different. This may happen due to differences in the execution mode, workloads, and other characteristics, of each edge node. To illustrate, imagine that storage edge node E₃ is selected to run the quantization selection procedure. In this example, all other edge nodes that finished their processing earlier must wait until E₃ finishes its procedure. In this way, the federated learning training may be delayed until E₃ completes.

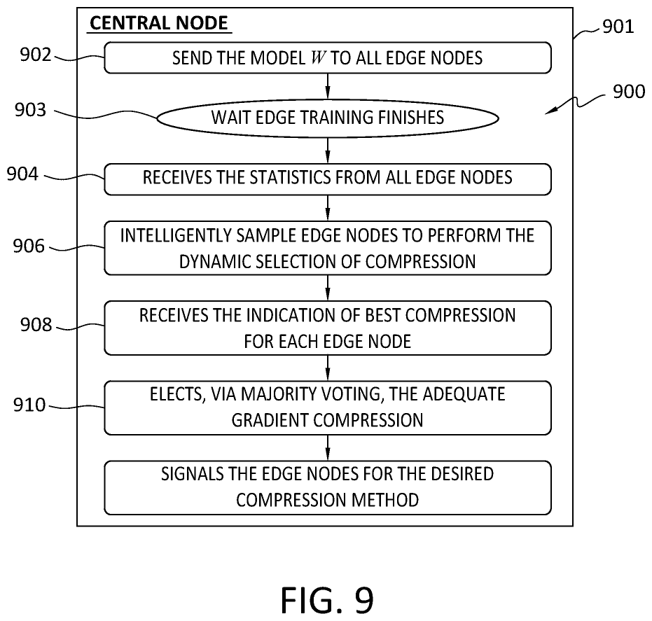

Thus, some example embodiments may be directed to a method for efficient sampling of the edge nodes to run the quantization procedure without slowing the federated learning process and while using only a small amount of statistics from the training performed inside the edge node. To this end, example embodiments may comprise a procedure to receive and process the statistics from the edge storage nodes and run the intelligent sampling algorithm. In general, the efficient sampling algorithm according to some embodiments may run inside the central node, which the federated learning processing uses to aggregate the learning information. Thus, example embodiments may not impose any additional processing or memory loads, for example, on any of the edge storage nodes. FIG. 9 shows aspects of an example method 900 that may execute inside a central node 901, that is, a method 900 to run an efficient sampling algorithm, the edge-weighted quantization and the federated learning procedure inside the central node 901.

The example method 900 may begin when the central node 901 sends 902 a model, such as an ML (machine learning) model for example, to a group of edge nodes, which may then train respective instances of the model using local edge node data. After waiting 903 for the training process to complete, the central node 901 may receive 904 statistics concerning the training from the edge nodes. The central node 901 may then perform 906 an intelligent, non-random, edge node sampling to identify edge nodes that will be used to identify, and select, a quantization process that meets established requirements and standards. After the sampling and selection of edge nodes are complete, the edge nodes may then run various quantization processes, and identify which quantization process provides the best performance. As a result, the central node 901 may receive 908, from each edge node, a respective indication as to which quantization process was identified by that edge node as providing the best performance. The central node 901 may then select 910, from among the various quantization processes identified by the edge nodes, the quantization process which best balances various competing criteria which may be tunable and weightable by a user or other entity, and may include, for example, gradient compression, model convergence, and number of training iterations required. The selection 910 may be performed in any suitable manner and, in some embodiments, may be as simple as selecting the quantization process identified by the most edge nodes as providing the best performance. After the selection 910 has been performed, the central node 901 may then inform 912 the edge nodes which quantization method should be used.

### C.2 Collecting Statistics on Edge Nodes—Sampled and Non-sampled

Among other things, example embodiments of the method may perform the collection of statistics from the procedures performed inside the edge nodes so that the central node may evaluate the best set of edge storage nodes to run the quantization selection procedure. Example embodiments include a framework that may have two types of edge nodes: (i) a sampled node; and (ii) a non-sampled node. Embodiments may operate to collect statistics about the federated learning training and the quantization selection procedure in the sampled nodes. On the other hand, from non-sampled nodes, embodiments may assemble statistics regarding the federated learning process only.

Regarding the type of statistics being collected inside each storage edge node, example embodiments may employ a variety of possibilities. Examples of such statistics include, but are not limited to, the training time of the federated learning procedure, the memory usage, and time to run the quantization selection procedure for sampled nodes.

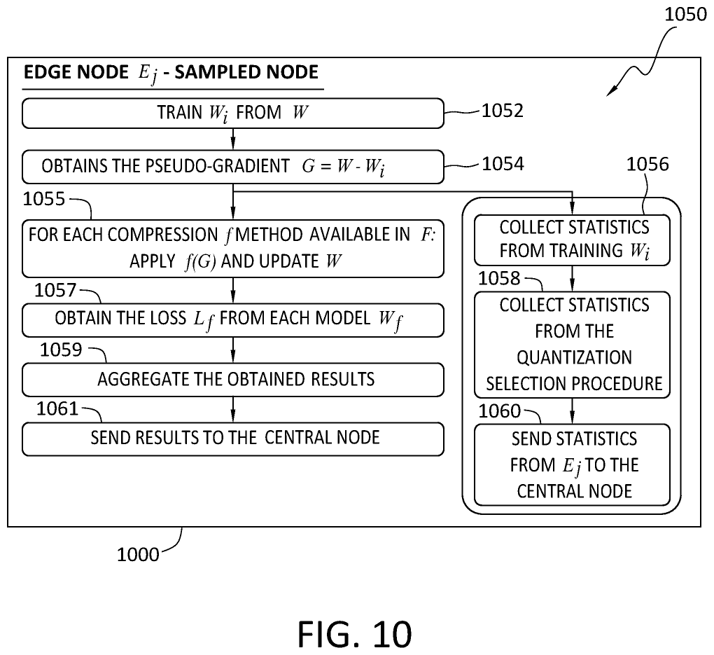

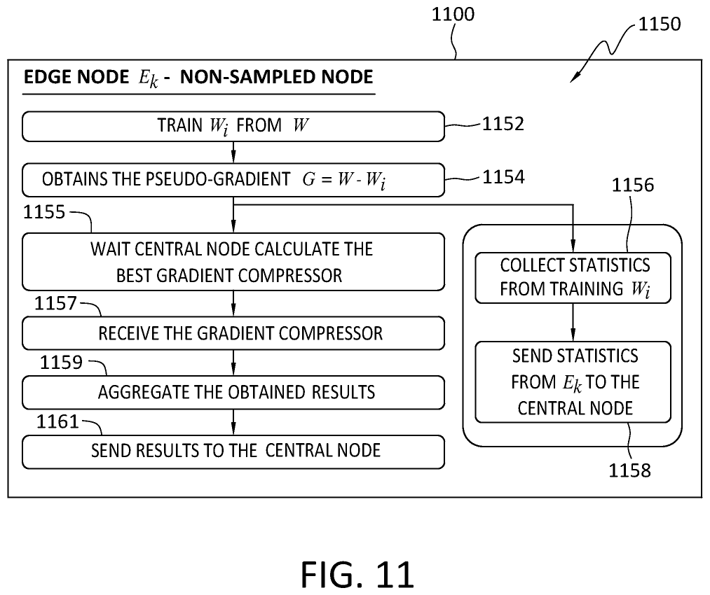

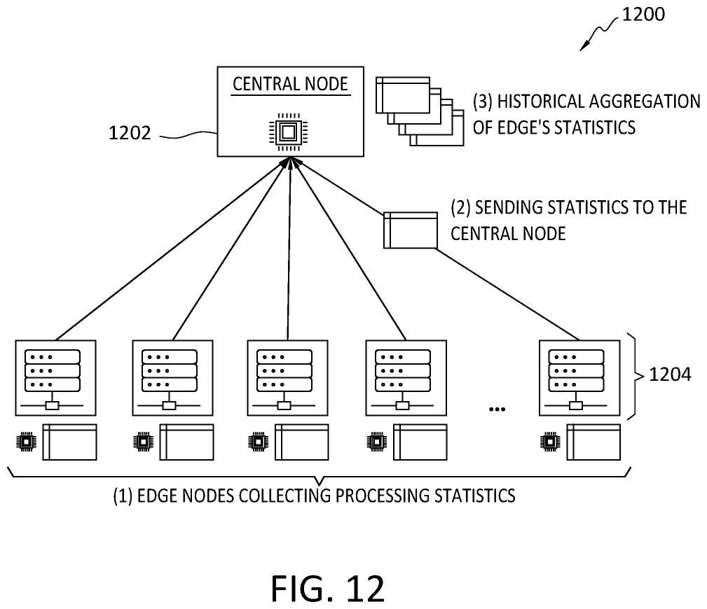

FIGS. 10 and 11 describe running the procedures and collecting the statistics inside the edge storage node. In particular, FIG. 10 discloses a flowchart of the operations that may be performed by a sampled node 1000. A sampled node is a node that may run both the federated learning procedure and the quantization selection procedure. By way of contrast, FIG. 11 discloses a flowchart of the operations that may be performed by a non-sampled node 1100. A non-sampled node is an edge node that does not run the quantization selection procedure. Finally, FIG. 12 discloses an example process 1200 of sending statistics from edge nodes to the central node.

### C.2.1 Statistics Collection—Sampled Node

With more particular reference now to FIG. 10, an example method 1050 may be performed at the edge node 1000, and may begin with the training 1052 of the local instantiation Wᵢ of the model W. During, or subsequent to the training 1052, the pseudo-gradient G may be obtained 1054. The edge node 1000 may collect 1056 statistics from the training process 1052, and because the edge node 1000 is a sampled node, the edge node 1000 may also collect 1058 statistics from a quantization selection procedure. Both the training process statistics and the quantization selection procedure statistics may be sent 1060 to a central node.

At the same time as, or at another time, as the process 1056/1058/1060 is being performed, the edge node 1000 may also evaluate 1055 each compression method available at the edge node 1000. The loss experienced by the model W for each different compression method may then be obtained 1057. The results obtained at 1057 may then be aggregated 1059, and sent 1061 to the central node.

### C.2.2 Statistics Collection—Non-sampled Node

With attention next to FIG. 11, details are provided concerning the flowchart of the operations in a method 1150 performed by the non-sampled node 1100. The example method 1150 may begin with the training 1152 of the local instantiation Wᵢ of the model W. After the training 1152, the pseudo-gradient G may be obtained 1154. The edge node 1100 may also collect 1156 statistics from the training process 1152, and send 1158 those statistics to a central node.

After the pseudo-gradient G has been obtained 1154, the non-sampled node 1100 may wait 1155 for the central node to calculate the gradient compressor, or other quantizer, having the best performance. The non-sampled node 1100 may then receive 1157 the best-performing compressor from the central node, aggregate 1159 the results obtained from the use of the compressor, and send 1161 those results to the central node.

### C.2.3 Statistics Collection—Central Node

With attention now to FIG. 12, a configuration 1200 is disclosed that includes a central node 1202 that may communicate, such as for the purpose of collecting statistics for example, with one or more edge nodes 1204 of a group of edge nodes. An example method for collecting, by the central node 1202 from the edge node(s) 1204, statistics may include (1) the edge nodes 1204 collecting processing statistics concerning operation of one or more compressors, and/or statistics concerning the operation of a model W; (2) sending the collected statistics from each edge node 1204 to the central node 1202, for future aggregation; and (3) historical aggregation, at the central node 1202, of statistics collected from each edge node 1204.

Note that in environments with large number of nodes, it may be the case that only a subset of nodes may be required to update their statistics in a cycle. The central node may use the most-recent available statistics for each edge node, and disregard those for which no known statistics are available and/or disregard those edge nodes which have not recently provided any statistics. This approach may reduce the communication overheads, which may be important for the central node in particular.

### C.3 Historical Data Processing

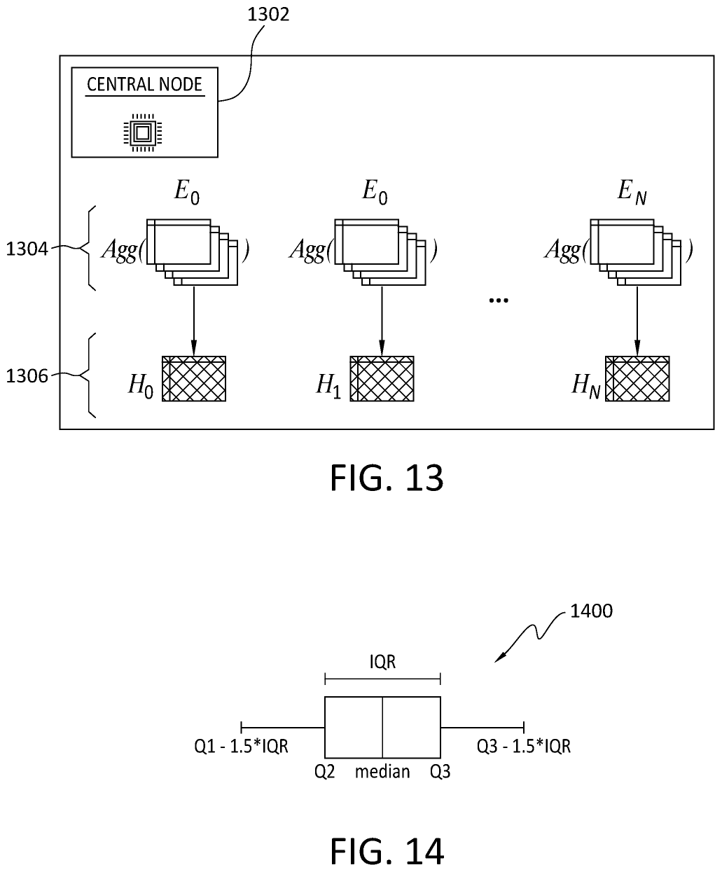

With reference now to the example of FIG. 13, once the statistics data arrive in the central node 1302, embodiments of the invention may operate to process that data. To that end, example embodiments may employ, in the central node 1302, an aggregation procedure 1304 that may operate to collect statistics from a single edge node Eᵢ and transform the statistical data into a historical data table 1306 that may be stored in the central node 1302. Note that the statistics may be sent to the central node 1302 after the end of each federated learning training cycle. This approach may make the historical data generation asynchronous. A historical data table Hᵢ may be associated with an edge node Eᵢ. The aggregation function A_{gg} may be selected from various options including, but not limited to, mean, median, mode, and histogram, for example. Also, the aggregation function may take additional parameters to discard old statistics or even outliers. For example, an aggregation function 1304 may use only the statistics from the past ten cycles to generate the historical data 1306. The aggregation may be performed after several federated learning cycles and, in some embodiments, the aggregation process may run after the end of every cycle. This is shown in FIG. 13, which discloses, in the central node 1302, the collections of statistical data being assembled by using an aggregation function 1304. After this process, the historical data 1306 may be kept inside the central node 1302 to be used by the efficient sampling algorithm.

### C.4 Efficient Sampling of Edge Nodes for Edge-weighted Quantization

Some example embodiments of a method for the efficient sampling of edge nodes may operate as follows. First, after aggregating statistics collected from the edge nodes, embodiments may estimate the time that each one of the edge nodes uses to run their federated learning training and the quantization selection procedure, when available. These times may be aggregated using the mean value from the past t federated learning cycles. During the first t iterations, there may not be enough information to run any efficient algorithm, so example embodiments may initially perform a naïve sampling, such as a random sampling for example.

After t iterations of a federated learning cycle, in order to select, or sample, the edge nodes, embodiments may first calculate the composite time formed by the federated learning training time and the execution time of the quantization selection procedure. When the latter is not available, its value may be set as zero. Then, example embodiments may create a boxplot, as shown at 1400 in FIG. 14, with the composite mean times. Those values that are greater than Q3+1.5*IQR may be considered as outliers and, as a consequence, may not be selected by the sampling algorithm. The idea behind removing, or not selecting, the outliers is that those outlier edge nodes may be considered time-consuming in terms of their ability to run a quantization procedure, so picking those outliers may postpone the end of the federated learning training cycle because it has to wait until the quantization selection procedure ends on every machine selected to run. FIG. 14 shows an example of the boxplot 1400 that may be used to identify outliers.

Once the outlier boundary has been selected, example embodiments may add a pre-defined constant ε to this value. This may allow for a better fine-tunning of the selection on different application domains. In the end, all edge nodes with historical mean composite time lower than the threshold δ=Q3+1.5*IQR+ε may be considered suitably efficient and selected to run the quantization selection procedure. After the end of the cycle, the historical values may be updated, and the process repeated.

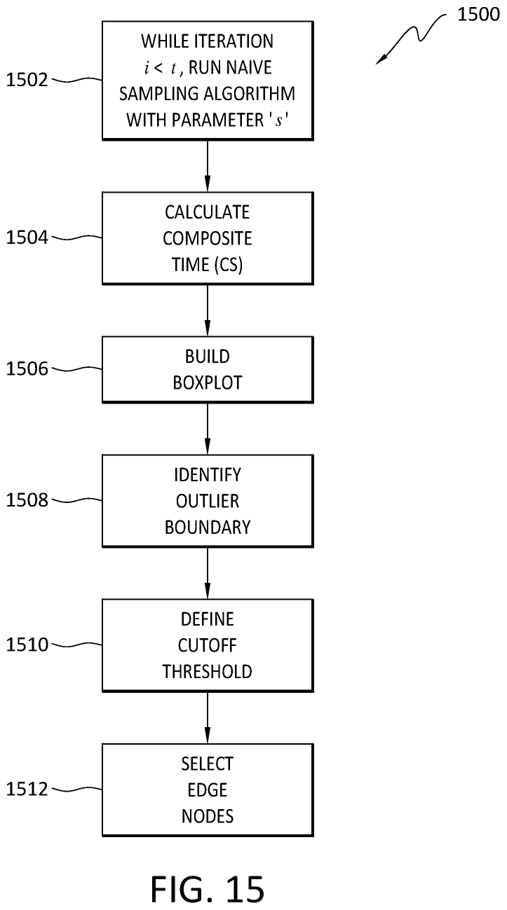

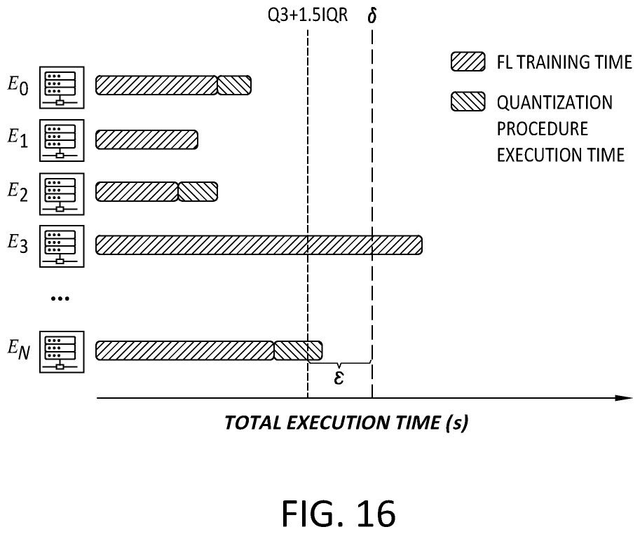

In more detail, and with continued reference to FIG. 14, and directing attention as well to FIGS. 15 and 16, the boxplot 1400 may be used to calculate the Interquartile Range (IQR) and find outliers when the value of the composite time is higher than the third quartile (Q3) plus 1.5 IQR. An efficient sampling algorithm 1500, which may be performed at a central node for example, according to some example embodiments may operate as follows:
1502—while the number of iterations<t, run a naïve sampling algorithm with parameter s;
1504—from historical statistics, calculate the composite, or total, time (cs) formed by a sum of (i) the federated learning training time and (ii) the execution time of the quantization selection procedure;
1506—build a boxplot from the composite times;

1508—use the boxplot to identify the outlier boundary using the IQR formula: Q3+1.5*IQR;
1510—define the final cutoff threshold δ as, δ=Q3+1.5*IQR+ε, where ε is a threshold to allow flexibility to the application of the method on different domains; and
1512—select the edge nodes Eₛ∈E, where cs<δ.

FIG. 16 discloses a general overview of the method example 1500 applied to a variety of edge nodes E₀ . . . E_{N}. In FIG. 16, the composite times are represented by the different shadings indicated in the legend.

### D. Further Discussion

As disclosed herein, example embodiments may provide various useful features and advantages. For example, embodiments may provide a mechanism to efficiently sample edge nodes capable of performing an edge-weighted quantization process, but without delaying the federated learning cycle. Embodiments may provide an edge sampling algorithm based solely on the historical information of the edge nodes execution times of the procedures of interest. An embodiment may operate to train FL models with dynamic selection of gradient compression at the central node, based on an edge-side assessment of the estimated convergence rate at selected edge nodes. An embodiment may operate to substantially minimize the risk of selecting impaired edge nodes and facing delays and/or inaccurate selection of a quantization level.

### E. Example Methods

It is noted with respect to the disclosed methods, including the example method of FIG. 15, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. Further Example Embodiments

Following are some further example embodiments of the invention. These are presented only by way of example and are not intended to limit the scope of the invention in any way.

Embodiment 1. A method, comprising performing operations including: running an edge node sampling algorithm using a parameter ‘s’ that specifies a number of edge nodes to be sampled; using historical statistics from the edge nodes, calculating a composite time for each of the edge nodes, and the composite time comprises a sum of a federated learning time and an execution time of a quantization selection procedure; identifying an outlier boundary; defining a cutoff threshold based on the outlier boundary; and selecting, for sampling, the edge nodes that are at or below the cutoff threshold.

Embodiment 2. The method as recited in embodiment 1, further comprising running, at the selected edge nodes, the quantization selection procedure.

Embodiment 3. The method as recited in any of embodiments 1-2, wherein the quantization selection procedure identifies a quantization procedure that meets one or more established parameters.

Embodiment 4. The method as recited in embodiment 3, wherein when the quantization procedure is run, the quantization procedure operates to quantize a gradient generated by one of the edge nodes.

Embodiment 5. The method as recited in embodiment 4, wherein the gradient comprises information about performance of a federated learning process at one of the edge nodes.

Embodiment 6. The method as recited in embodiment 4, wherein quantization of the gradient comprises compression of the gradient.

Embodiment 7. The method as recited in any of embodiments 1-6, wherein the outlier boundary is identified using a boxplot.

Embodiment 8. The method as recited in any of embodiments 1-7, wherein the cutoff threshold is a maximum permissible composite time.

Embodiment 9. The method as recited in any of embodiments 1-8, wherein the operations are performed at a central node that communicates with the edge nodes.

Embodiment 10. The method as recited in any of embodiments 1-9, wherein the edge nodes are non-randomly sampled.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

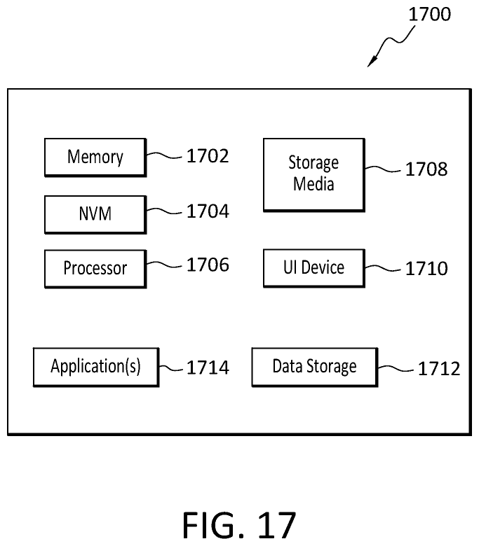

With reference briefly now to FIG. 17, any one or more of the entities disclosed, or implied, by FIGS. 1-16 and/or elsewhere herein, may take the form of, or include, or be implemented on, or hosted by, a physical computing device, one example of which is denoted at 1700. As well, where any of the aforementioned elements comprise or consist of a virtual machine (VM), that VM may constitute a virtualization of any combination of the physical components disclosed in FIG. 17.

In the example of FIG. 17, the physical computing device 1700 includes a memory 1702 which may include one, some, or all, of random access memory (RAM), non-volatile memory (NVM) 1704 such as NVRAM for example, read-only memory (ROM), and persistent memory, one or more hardware processors 1706, non-transitory storage media 1708, UI (user interface) device 1710, and data storage 1712. One or more of the memory components 1702 of the physical computing device 1704 may take the form of solid state device (SSD) storage. As well, one or more applications 1714 may be provided that comprise instructions executable by one or more hardware processors 1706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising performing operations including:
running an edge node sampling algorithm using a parameter ‘s’ that specifies a number of edge nodes to be sampled;
using historical statistics from the edge nodes, calculating a composite time for each of the edge nodes, and the composite time comprises a sum of a federated learning time and an execution time of a quantization selection procedure;
identifying an outlier boundary;
defining a cutoff threshold based on the outlier boundary; and
selecting, for sampling, the edge nodes that are at or below the cutoff threshold.

2. The method as recited in claim 1, further comprising running, at the selected edge nodes, the quantization selection procedure.

3. The method as recited in claim 1, wherein the quantization selection procedure identifies a quantization procedure that meets one or more established parameters.

4. The method as recited in claim 3, wherein when the quantization procedure is run, the quantization procedure operates to quantize a gradient generated by one of the edge nodes.

5. The method as recited in claim 4, wherein the gradient comprises information about performance of a federated learning process at one of the edge nodes.

6. The method as recited in claim 4, wherein quantization of the gradient comprises compression of the gradient.

7. The method as recited in claim 1, wherein the outlier boundary is identified using a boxplot.

8. The method as recited in claim 1, wherein the cutoff threshold is a maximum permissible composite time.

9. The method as recited in claim 1, wherein the operations are performed at a central node that communicates with the edge nodes.

10. The method as recited in claim 1, wherein the edge nodes are non-randomly sampled.

11. A non-transitory storage medium having stored therein instructions that are executable by one or more hardware processors to perform operations comprising:
running an edge node sampling algorithm using a parameter ‘s’ that specifies a number of edge nodes to be sampled;
using historical statistics from the edge nodes, calculating a composite time for each of the edge nodes, and the composite time comprises a sum of a federated learning time and an execution time of a quantization selection procedure;
identifying an outlier boundary;
defining a cutoff threshold based on the outlier boundary; and
selecting, for sampling, the edge nodes that are at or below the cutoff threshold.

12. The non-transitory storage medium as recited in claim 11, further comprising running, at the selected edge nodes, the quantization selection procedure.

13. The non-transitory storage medium as recited in claim 11, wherein the quantization selection procedure identifies a quantization procedure that meets one or more established parameters.

14. The non-transitory storage medium as recited in claim 13, wherein when the quantization procedure is run, the quantization procedure operates to quantize a gradient generated by one of the edge nodes.

15. The non-transitory storage medium as recited in claim 14, wherein the gradient comprises information about performance of a federated learning process at one of the edge nodes.

16. The non-transitory storage medium as recited in claim 14, wherein quantization of the gradient comprises compression of the gradient.

17. The non-transitory storage medium as recited in claim 11, wherein the outlier boundary is identified using a boxplot.

18. The non-transitory storage medium as recited in claim 11, wherein the cutoff threshold is a maximum permissible composite time.

19. The non-transitory storage medium as recited in claim 11, wherein the operations are performed at a central node that communicates with the edge nodes.

20. The non-transitory storage medium as recited in claim 11, wherein the edge nodes are non-randomly sampled.
